(19) United States
(12) Patent Application Publication
(10) Pub. No.: US 2009/0269859 A1
(43) Pub. Date: Oct. 29, 2009

(54) Mobile Bead Configuration Immunoaffinity Column and Methods of Use

(75) Inventor: Jianmin Liu, Framingham, MA (US)

Correspondence Address: EDWARDS ANGELL PALMER & DODGE LLP, P.O. BOX 55874, BOSTON, MA, 02205, US

(73) Assignee: Waters Investments Limited, New Castle (US)

(21) Appl. No.: 12/162,494

(22) PCT Filed: Jan. 25, 2007
(86) PCT No.: PCT/US07/02303

§ 371 Date: Dec. 18, 2008

Related U.S. Application Data
(60) Provisional application No. 60/771,708, filed on Feb. 9, 2006.

(51) Int. Cl. G01N 33/538; G01N 30/02

(52) U.S. Cl. 436/541; 422/70

(57) ABSTRACT

It has been discovered that a column configuration which allows for suspension of the beads, such as a mobile bead, during washing results in significantly lower levels of background and hence more sensitive levels of quantitation. The present invention provides columns, kits, and methods for more sensitive detection of a toxin or other analyte.

### RELATED APPLICATION

This application claims priority to: U.S. provisional application Ser. No. 60/771,708 filed 9 Feb. 2006. The aforementioned application is incorporated herein in its entirety by this reference.

### FIELD OF THE INVENTION

The invention relates to affinity columns such as those used for immunological screening for environmentally occurring toxins, for example, those toxins found in food products, and is particularly useful for detecting Aflatoxins with high sensitivity in dairy products. It has been discovered that a column configuration which allows for suspension of the beads, such as a mobile bead, during washing results in significantly lower levels of background and hence more sensitive levels of quantitation. The present invention provides columns, kits, and methods for more sensitive detection of a toxin or other analyte.

### BACKGROUND OF THE INVENTION

The incidence and effect of exposure to toxic substances by humans and other animals via food, water, and air is of critical importance to our survival. The detection of toxins such as aflatoxin, ochratoxin, zearalenone, deoxynivalenol and fumonisin has become especially important. In particular, screening procedures for assessing the exposure of humans to such toxins may require the ability to quantify both the toxin and its metabolites. There have been numerous reported incidences of naturally occurring mycotoxins such as, aflatoxin B₁, B₂, G₁, G₂ and M₁ (Afla), deoxynivalenol (DON), fumonisin B₁, B₂ and B₃, ochratoxin A (OTA), and zearalenone (Zear) in various substrates. Malt beverages and wines can contain different multi-toxin combinations from fungi-infected grains and fruits used in the production. Milk, tea, and coffee can also contain some of these toxins.

Aflatoxins are a typical example of the compounds for which screening is desired. Aflatoxins are secondary fungal metabolites, mycotoxins, which are produced by Aspergillus flavus and Aspergillus parasiticus and are structurally a group of substituted coumarins containing a fused dihydrofurofuran moiety. Aflatoxins occur naturally in peanuts, peanut meal, cottonseed meal, corn, dried chili peppers, and the like. However, the growth of the mold itself does not predict the presence or levels of the toxin because the yield of aflatoxin depends on growth conditions as well as the genetic requirements of the species. A variety of aflatoxins, that is types B₁, B₂, G₁, G₂, M₁ and M₂, have been isolated and characterized. Aflatoxin B₁ (“AFB₁”) is the most biologically potent of these aflatoxins and has been shown to be toxic, mutagenic and carcinogenic in many animal species. This mycotoxin is a frequent contaminant of the human food supply in many areas of the world and is statistically associated with increased incidence of human liver cancer in Asia and Africa, in particular (Busby et al., in Food-Born Infections and Intoxications (Riemann and Bryan, Editors) Second Edition, Academic Press, Inc., 1979, pp. 519-610; Wogan, G. N. Methods Cancer Res. 7:309-344 (1973)).

Some investigations regarding quantitation of AFB₁ and its metabolites including its DNA adduct have been conducted using immunological techniques and monoclonal antibodies (Hertzog et al., Carcinogensis 3:825-828 (1982); Groopman et al., Cancer Res. 42:3120-3124 (1982); Haugen et al., Proc. Natl. Acad. Sci. USA 78: 4124-4127 (1981)). Similar research has been conducted utilizing immunological techniques and reagents for other low molecular weight toxins found in our environment (Johnson et al., J. Analyt. Toxicol. 4:86-90 (1980); Sizaret et al., J.N.C.I. 69:1375-1381 (1982); Hu et al., J. Food Prot. 47:126-127 (1984); and Chu, J. Food Prot. 47:562-569 (1984)).

U.S. Pat. No. 4,818,687 (granted Apr. 4, 1989) and U.S. Pat. No. 4,859,611 (granted Aug. 22, 1989) describe a general non-invasive screening procedure for assessing the exposure of humans and animals to environmentally occurring carcinogens. Therein, an affinity matrix and a method for the detection of low molecular weight compositions, such as aflatoxins, are provided utilizing specific monoclonal IgM antibody.

AFB₁ found in feed may also be ingested by dairy cows and subsequently metabolized to aflatoxin M₁ (“AFM₁”). AFM₁ is approximately 75% as toxic to ducklings as AFB₁ (Purchase, I. F. H., Food Cosmet. Toxicol., 5:339-342 (1969)). Consequently, many countries regulate the maximum permissible of AFM₁ found in milk and milk products. The action level for AFM₁ in milk established by the US Food and Drug Administration is 0.5 ng/ml (500 parts per trillion, 500 ppt). The European Union regulates AFM₁ in milk more stringently at 50 ppt for adults and 25 ppt for infant formula. Raw milk is a colloidal suspension

Monitoring of levels of AFM₁ by dairy operations or milk producers requires a rapid, accurate, sensitive and inexpensive method of analysis. Methods for analysis of AFM₁ have been published utilizing either liquid-liquid extraction (Stubblefield, R. D. J. Amer. Oil Chem. Soc. 56:800-802 (1979), Chang, H. L. and DeVries, J. W. JOAOC 66:913-917 (1983)) or solid phase extraction (Gauch, R et al., J. Chromatogr. 178:543-549 (1979)) followed by silica gel column or other cleanup (Takeda, N. J. Chromatogr. 288:484-488 (1984)) and quantitation by thin layer chromatography or liquid chromatography.

Methods relying on extraction of AFM₁ by immunoaffinity columns have also been published. This approach circumvents some of the slow and laborious preparation of the methods given above. However, quantitation of the AFM₁ by HPLC after immunoaffinity cleanup (Dragacci, S, and Grosso JOAOC 84:437-443 (2001)) still requires expensive equipment and a certain degree of technical expertise. Quantitation by fluorometer after immunoaffinity cleanup (Hansen, T. J. Food Protection 53:75-77 (1990)) requires less expensive equipment, is faster and simpler, but has a reported detection limit of 50 ppt which is not adequate when quantitation is required at lower concentrations than 50 ppt.

The limit of quantitation using a fluorometer has been constrained by the level of fluorescent background materials not removed by the immunoaffinity column purification. Typically in such a column antibody bound to a resin or other solid medium is held between two porous frits and non-specifically bound fluorescent background material is removed by washing with an appropriate buffer. Pockets or bubbles of air or other gases may become trapped within the resin and may reduce efficient washing of the resin. It is believed that these entrapped pockets or bubbles may reduce the sensitivity of the column.

There is a need for a more sensitive method of measuring contaminants in a liquid or colloidal sample, particularly one that is relatively rapid, simple, and inexpensive, such as quantitation of aflatoxin in milk using a fluorometer after immunoaffinity column purification.

### SUMMARY OF THE INVENTION

In one aspect, the present invention provides a method of analyzing a single liquid sample for detecting the presence of an analyte in a sample or for analyzing the level of an analyte in a sample, wherein the method comprises:
a. providing an immunoaffinity column comprising a mobile resin configuration, wherein the immunoaffinity column comprises:
   i. a lower end including an outflow opening;
   ii. a lower porous support;
   iii. a layer of resin on the lower porous support, the resin having specific affinity for the analyte;
   iv. an upper porous support; and
   v. an upper end including an inflow opening;
wherein the resin between the lower porous support and the upper porous support is structured and arranged to permit removal of the upper frit from the column without substantial removal of resin;
b. loading the column with a predetermined amount of a liquid sample suspected of containing the analyte;
c. binding the analyte to the antibody on the column;
d. loading the column with a wash solution
e. suspending the resin in the wash solution;
f. removing the wash solution from the column;
g. eluting the analyte in eluant; and
h. analyzing the eluant for the presence of the analyte.

In one embodiment, the volume of the resin in the column is less than the total packed volume of the column between the lower porous support and the upper porous support.

In one embodiment, the column is structured and arranged to recover at least 60% of the analyte in a 40 ml sample being analyzed, the analyte being selected from the group consisting of ochratoxin, zearalenone, aflatoxin, fiimonisin, T-2, HT-2, and deoxynivalenol.

In various embodiments, the column has a detection limit at or below about 100 ppt, 50 ppt, 25 ppt, 15 ppt, or 12.5 ppt.

In another aspect, the present invention provides an immunoaffinity column comprising a mobile resin configuration for detecting the presence of an analyte in a sample or for analyzing the level of an analyte in a sample, wherein the immunoaffinity column comprises:
a. a lower end including an outflow opening;
b. a lower porous support;
c. a layer of resin on the lower porous support, the resin having specific immunoaffinity for the analyte;
d. an upper porous support; and
e. an upper end including an inflow opening;
   wherein the resin between the lower porous support and the upper porous support is structured and arranged to permit removal of the upper frit from the column without substantial removal of resin.

In yet another aspect, the present invention provides a kit for detecting the presence of an analyte in a sample or for analyzing the level of an analyte in a sample, wherein the kit comprises:
a. the immunoaffinity column described above and having a mobile resin configuration;
b. a removable cap covering the lower end to prevent transfer of substances through the outflow opening;
c. a removable cap covering the upper end to prevent transfer of substances through the inflow opening; and
d. instructions for use.

### BRIEF DESCRIPTION OF THE DRAWINGS

FIG. 1 is a schematic cross-section depicting an embodiment of the mobile bead column of the present invention.

FIG. 2 is a graph showing the linear regression analysis equation for the amount of aflatoxin M₁ measured by fluorometer (y axis) versus the amount spiked (x axis) from analysis of spiked samples using a mobile bead column of the present invention.

### DETAILED DESCRIPTION OF THE INVENTION

It has been discovered that a column configuration which allows for suspension of the beads, such as a mobile bead, during washing results in significantly lower levels of background and hence more sensitive levels of quantitation. The present invention provides columns, kits, and methods for more sensitive detection of a toxin or other analyte.

It has been discovered that a column configuration which allows for suspension of the beads, such as a mobile bead column (e.g., a mobile bead configuration column) or other resin during washing results in significantly lower levels of background fluorescence and hence more sensitive levels of quantitation.

The present invention provides an immunoaffinity column capable of analyzing a single sample containing aflatoxin. In one embodiment, the column in accord with the present invention comprises a quantity of resin comprising an antibody having specificity for a toxin (e.g., aflatoxin), the resin being fixed between two semi-porous frits such that the resin beads may be suspended and such that the upper frit may be removed during washing of the resin to remove fluorescent background compounds.

In a preferred embodiment, the column of the present invention is capable of analyzing a sample to detect aflatoxins M₁, G₁, G₂, B₁, and B₂.

The invention also provides a method for analyzing a single sample for a toxin e.g., aflatoxin), the method comprising providing a column as described herein, applying liquid sample suspected of containing one or more of the specified toxins to bind to resins in the column, washing the column, eluting the resins and analyzing the eluant for the presence of the specified toxins.

The present invention provides affinity columns, methods, and kits used for immunological screening for environmentally occurring toxins, for example, those found in food products, and is particularly useful for detecting aflatoxins with high sensitivity in dairy products.

In one aspect, the present invention provides a method of analyzing a single liquid sample for detecting the presence of an analyte in a sample or for analyzing the level of an analyte in a sample, wherein the method comprises:
a. providing an immunoaffinity column comprising a mobile resin configuration, wherein the immunoaffinity column comprises:
   i. a lower end including an outflow opening;
   ii. a lower porous support;
   iii. a layer of resin on the lower porous support, the resin having specific affinity for the analyte;
   iv. an upper porous support; and
   v. an upper end including an inflow opening;
wherein the resin between the lower porous support and the upper porous support is structured and arranged to permit removal of the upper frit from the column without substantial removal of resin;
b. loading the column with a predetermined amount of a liquid sample suspected of containing the analyte;
c. binding the analyte to the antibody on the column;
d. loading the column with a wash solution
e. suspending the resin in the wash solution;
f. removing the wash solution from the column;
g. eluting the analyte in eluant; and
h. analyzing the eluant for the presence of the analyte.

In one embodiment, the volume of the resin in the column is less than the total packed volume of the column between the lower porous support and the upper porous support. Preferably, the volume of the resin in the column is no greater than 50%, more preferably no greater than 40%, even more preferably no greater than 30%, still more preferably no greater than 25%, and still more preferably no greater than 20% of the total packed volume of the column between the lower porous support and the upper porous support.

In another embodiment, the column is structured and arranged to recover at least about 60%, preferably at least about 70%, and more preferably about 80% of the analyte in a 40 ml sample being analyzed, the analyte being selected from the group consisting of ochratoxin, zearalenone, aflatoxin, fumonisin, T-2, HT-2, and deoxynivalenol.

In yet another embodiment, the sample comprises milk or a milk product and the analyte is an aflatoxin. Preferably, the aflatoxin is aflatoxin G₁, G₂, B₁, B₂, or M₁. More preferably, the aflatoxin is aflatoxin M₁.

In a preferred embodiment, the column has a detection limit at or below about 100 ppt, more preferably at or below about 50 ppt, even more preferably at or below about 25 ppt, still more preferably at or below about 15 ppt, still more preferably at or below about 12.5 ppt.

In another embodiment, the column is structured and arranged to have a flow rate of sample fluid through the column of at least about 1-2 drops per second.

In yet another embodiment, the resin comprises about S mg of antibody per ml of resin.

In still another embodiment, the column further comprises at least one of the following:
a. a removable cap covering the lower end to prevent transfer of substances through the outflow opening; or
b. a removable cap covering the upper end to prevent transfer of substances through the inflow opening; and
   and wherein the resin is suspended by at least one inversion of the column.

In one embodiment, the analyte is extracted from a food using a water-based or water compatible solvent. Preferably, the food comprises a milk product.

In another embodiment, the analyte is extracted from milk or a milk product. Preferably, the analyte is extracted from de-fatted milk.

In one embodiment, the resin is suspended by inversion of the column, by vortexing the column, or by shaking the column. Preferably, the resin is suspended by inverting the column until the resin is released from the lower porous support.

In yet another embodiment, the upper porous support is removed from the column following the step of binding the analyte to the antibody on the column.

In another aspect, the present invention provides an immunoaffinity column comprising a mobile resin configuration for detecting the presence of an analyte in a sample or for analyzing the level of an analyte in a sample, wherein the immunoaffinity column comprises:
a. a lower end including an outflow opening;
b. a lower porous support;
c. a layer of resin on the lower porous support, the resin having specific immunoaffinity for the analyte;
d. an upper porous support; and
e. an upper end including an inflow opening;
   wherein the resin between the lower porous support and the upper porous support is structured and arranged to permit removal of the upper frit from the column without substantial removal of resin.

In one embodiment, the volume of the resin in the column is less than the total packed volume of the column between the lower porous support and the upper porous support. Preferably, the volume of the resin in the column is no greater than 50%, more preferably no greater than 40%, even more preferably no greater than 30%, still more preferably no greater than 25%, and still more preferably no greater than 20% of the total packed volume of the column between the lower porous support and the upper porous support.

In another embodiment, the column is structured and arranged to recover at least about 60%, preferably at least about 70%, and more preferably about 80% of the analyte in a 40 ml sample being analyzed, the analyte being selected from the group consisting of ochratoxin, zearalenone, aflatoxin, fumonisin, T-2, HT-2, and deoxynivalenol.

In yet another embodiment, the sample comprises milk or a milk product and the analyte is an aflatoxin. Preferably, the aflatoxin is aflatoxin G₁, G₂, B₁, B₂, or M₁. More preferably, the aflatoxin is aflatoxin M₁.

In a preferred embodiment, the column has a detection limit at or below about 100 ppt, more preferably at or below about 50 ppt, even more preferably at or below about 25 ppt, still more preferably at or below about 15 ppt, still more preferably at or below about 12.5 ppt.

In another embodiment, the column is structured and arranged to have a flow rate of sample fluid through the column of at least 1-2 drops per second.

In yet another embodiment, the resin comprises about 5 mg of antibody per ml of resin.

In still another embodiment, the column further comprises at least one of the following:
a. a removable cap covering the lower end to prevent transfer of substances through the outflow opening; or
b. a removable cap covering the upper end to prevent transfer of substances through the inflow opening;
   and wherein the resin is suspended by at least one inversion of the column.

In yet another aspect, the present invention provides a kit for detecting the presence of an analyte in a sample or for analyzing the level of an analyte in a sample, wherein the kit comprises:
a. the immunoaffinity column described above and having a mobile resin configuration;
b. a removable cap covering the lower end to prevent transfer of substances through the outflow opening;
c. a removable cap covering the upper end to prevent transfer of substances through the inflow opening; and
d. instructions for use.

In one embodiment, (a) the volume of the resin is less than the total packed volume of the column between the lower porous support and the upper porous support; and (b) the column has a detection limit at or below about 50 ppt.

Preferably, the volume of the resin is no greater than about 50%, more preferably no greater than about 25%, and even more preferably no greater than about 20% of the total packed volume of the column between the lower porous support and the upper porous support

Preferably, the column has a detection limit at or below about 25 ppt, more preferably at or below about 15 ppt, and even more preferably at or below about 12.5 ppt.

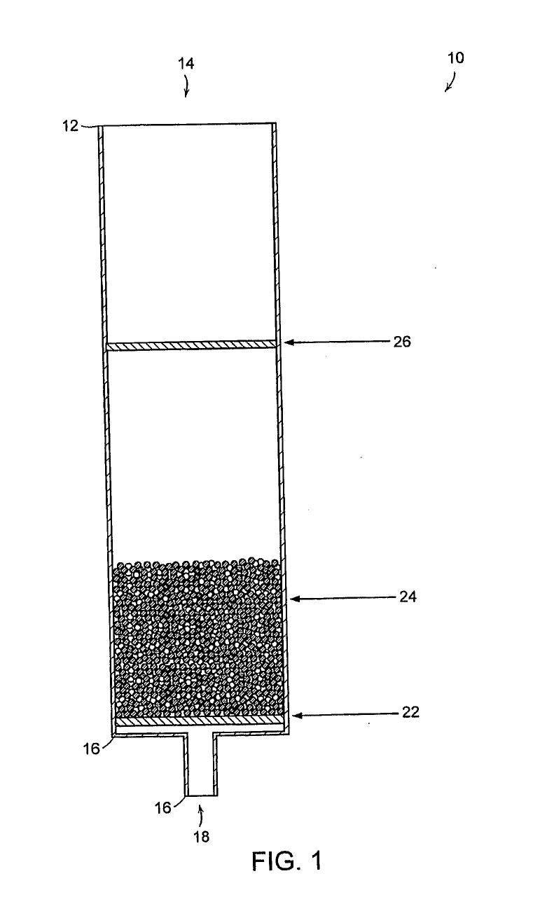

FIG. 1 is a schematic cross-section depicting one embodiment of the mobile bead column of the present invention. The vertical column (10) has an upper end (12) having an inflow opening (14) and a lower end (16) having an outflow opening (18) such that liquids or colloids enter the column through the inflow opening (14) and exit it through the outflow opening (18). In a preferred embodiment, the two ends (12, 16) are fitted with caps of appropriate dimensions and materials to prevent or inhibit the contents of the column from exiting the column, even when the column is inverted. These types of caps are known to those of ordinary skill in the art.

The column has a lower frit (22) positioned at or near the base of the column. A layer of resin (24) rests on the lower frit (22). An upper frit (26) is positioned above the resin at a distance sufficient to permit the particles of the resin to have a degree of mobility within the column. The two frits (22, 26) have a porosity that enables them to confine the resin within the discrete space while allowing inflow and outflow of the liquid or colloidal sample.

The volume of the resin in the column is less than the total packed volume of the column between the lower support and the upper support. The packed volume of the column refers to the volume of the column between the lower support and the upper support not including any spaces between the beads when beads are packed into the portion of the column between the lower support and the upper support. The volume of resin between the upper and lower frits is sufficiently loose to enable removal of the upper frit without loss of resin to a degree that would statistically impact test results (which could yield an artificially low reading of the toxin concentration) or inadvertent mixing of particles or precipitates trapped on the upper frit.

For example, in one embodiment of the invention, in a 3 ml column having a diameter of 8.93 mm, a supporting lower porous disk, or the like, is positioned to permit flow out of the column, while another porous disk, or the like, if desired, is positioned one inch above the bottom of the column barrel. The positioning of the upper frit will depend on the amount of resin required for the test and the size of the column and can be determined without undue experimentation.

In one embodiment, a toxin (e.g., aflatoxin) is quantified in a sample (e.g., milk). In addition to distributing the test sample, the upper frit captures larger particles and precipitates (e.g., precipitates from refrigeration) in the test sample. Some of these particles and precipitates can contribute to detected background levels (e.g., background fluorescence) and decrease the sensitivity of the test being performed. In this embodiment, the upper frit is removed prior to washing to prevent the particles and/or precipitates from being solubilized by the elution solution, followed by their elution with the eluant and subsequent detection. For example, some particles or precipitates may be solubilized in an 80% or higher methanol solution, thereby increasing detected fluorescence.

The volume of a right circular cylinder is computed as V=πr²h, where V is the volume, r is the radius of the cylinder, and h is its height. For example, for a column having a diameter of 8.93 mm (r=0.4465 cm) with two frits positioned 1 inch (h=2.54 mm) apart, the volume of this space is approximately 1.5908 cm³ or 1590.8 μl (using π=3.14159). One of skill in the art would know, or would be able to determine without undue experimentation, the relative positioning of the frits with respect to the amount of resin loaded (for a 1-2 drop/second flow rate) in order to allow mobility of the beads or other resin between the frits to allow for suspension and washing.

In one embodiment, the volume of resin is no greater than 50% of the total packed volume. For example, in one embodiment of the column described above, 100-600 μl of a resin having an antibody specific for a toxin is layered on the disk. Preferably, the volume of resin is less than 50% of the total packed volume, more preferably less than 40%, even more preferably less than 30%, still more preferably less than 25%, and even still more preferably less than 20% of the total packed volume, but other factors could include, for example, the degree of affinity of the resin for the toxin and the impact of the buffers and other solutions used for washing and elution.

In accordance with the present invention, an immunoaffinity column capable of analyzing a single sample containing aflatoxins, can be prepared. Resins containing antibody having specificity for the toxins are required. Antibodies are raised by well known techniques and monoclonal antibodies are prepared having specificity for the toxin. Resins having antibody bound thereto is prepared by techniques well known to those skilled in the art. Any known resin material can be used. A preferred resin material is Sepahrose 4B from Amersham Biosciences (Piscataway, N.J.). The antibodies are then attached to the resin using techniques well known to those skilled in the art. Preferably, for example, about 5 mg of anti-aflatoxin antibody is bound to one ml of resin. The resin preferably has a particle size range of about 45 to about 165 μm.

Columns are then prepared using appropriate quantities of each resin. For example, in one embodiment of the invention, in a 3 ml column having a diameter of 8.93 mm, a supporting porous disk, or the like, is positioned that permits flow out of the column. Approximately 100-600 μl of a resin having an antibody specific for a toxin is layered on the disk. In one embodiment, 250 μl of a resin having an antibody specific for aflatoxin is layered on the disk. Finally, another porous disk, or the like, if desired, is positioned one inch above the bottom of the column barrel to contain the resin. Further, a suitable porous material can be used in place of the porous disk. Alternatively, the top of the column may simply be capped prior to suspension of the resin. The total amount of resin in the column should permit a sample fluid to flow through the column at a preferred rate of about 1-2 drops per sec.

Columns in accord with the present invention are used, for example, as a clean-up step in analysis of liquid and solid dairy products, in combination with detection utilizing a fluorometer. Typically, a sample of milk is centrifuged to separate fat and a portion of the de-fatted milk is passed over the immunoaffinity column. The top frit is optionally removed and the resin washed several times with a methanol water solution. At least one of the washes involves suspension of the resin (e.g., by capping and inverting the column one or more times and preferably several times manually or on a platform, by vortexing, by shaking, by agitating, or by a similar method). The aflatoxins are eluted with a methanol water solution, the eluate treated with a developing reagent and the fluorescence read in a pre-calibrated fluorometer. Other detection and analysis methods will occur to one of skill in the art.

It is also envisioned that the invention could be used to detect low levels of other toxins. For example, approximately 200-250 μl of a resin having an antibody specific for aflatoxin is layered on the disk. For example, approximately 100-250 μl of a resin having an antibody specific for ochratoxin is layered on the disk. For example, approximately 250-350 μl of a resin having an antibody specific for fumonisin is layered on the disk. For example, approximately 100-350 μl of a resin having an antibody specific for zearalenone is layered on the disk. For example, approximately 500-550 μl of a resin having an antibody specific for deoxynivalenol (“DON”) is layered on the disk. For example, approximately 250-350 μl of a resin having an antibody specific for T-2 and/or HT-2 is layered on the disk. One of skill in the art would be able to determine amounts and types of antibodies without undue experimentation.

The column of the present invention is capable of analyzing a sample to detect aflatoxins G₁, G₂, B₁, B₂ and M₁, DON, fumonisins B₁, B₂ and B₃, ochratoxin A, T-2 and HT-2 toxin, and zearalenone. Such resin typically will contain about 5 mg antibody per ml of resin. However, any suitable loading of antibody on the resin can be used in accord with quantities and methods well known to those skilled in the art

The total amount of resin in the column should permit a sample fluid to flow through the column at a preferred rate of about 1-2 drops per sec. The distance between the frits can be adjusted accordingly to allow thorough washing of the resin and suspension as described above.

For solid foods, preferably toxins are extracted from the food using a water-based or water compatible solvent such as, for example, water:methanol, water:acetonitrile, ethanol, water:ethanol, salt solutions, buffer solutions, and the like, etc. Such solvents are well known to those skilled in the art. Typically, in such solvents the organic component is greater. Extracts can be diluted with water prior to chromatography.

After loading the sample on the column, the column typically is washed to remove any extraneous materials that may be held up on the column so that only bound materials, i.e., the toxins, remain. The column generally can be washed with the water compatible solvent but typically having a greater water presence. Wash solutions include, but are not limited to, water:methanol, water:acetonitrile, ethanol, water:ethanol, salt solutions, buffer solutions (e.g., phosphate buffered saline); deionized water, and the like.

The volume of the resin in the column is less than the total packed volume of the column between the lower support and the upper support. The resin is loose within the column. During the washing step, the resin is suspended in the wash solution, for example, by capping and inverting the column one or more times and preferably several times manually or on a platform, by vortexing, by shaking, by agitating, or by a similar method, to increase the surface area of the resin which is exposed to the wash solution. Ideally, this suspension will minimize or prevent the formation of air pockets in the resin and/or will wash unbound, non-specific material (which might contribute to high background readings) from the beads prior to elution.

The column is eluted with solvents as is well known to those skilled in the art. The eluants are analyzed for the particular analytes using techniques including, but not limited to, photochemical analysis, post column derivatizer, ultraviolet and fluorescent detectors.

The columns in accord with the present invention can be used as a clean-up step in analysis of extracts from solid materials or of colloidal or liquid products such as milk and other beverages for aflatoxins, fumonisins, ochratoxin A, deoxynivalenol and zearalenone. The detection of the toxin can be illustrated, typically, by spiking a sample of a solid, extract, colloidal or liquid substance with toxins. The sample is loaded onto the column at a speed of about 1-2 drops/second Wash solutions include, but are not limited to, water:methanol, water:acetonitrile, ethanol, water:ethanol, salt solutions, buffer solutions (e.g., phosphate buffered saline), deionized water, and the like. The toxins are eluted from the column with methanol. Detection systems include, but are not limited to, photochemical, post-column derivatizer, ultra-violet and fluorescence detectors. Aflatoxins are detected by fluorescence after post-column photochemical derivitization (post-column iodine may also be used). Fumonisin is derivatized with o-phthaldialdehyde and detected by fluorescence. DON is detected by UV absorbance. Zearalenone is detected by fluorescence. Ochratoxin is detected by fluorescence. Methods for detecting the toxins are well known to those skilled in the art.

It is desirable to obtain at least a 60%, preferably at least a 70%, more preferably 80% recovery from the column for each toxin in the sample. It also is desirable to have the running of the column and detection completed within 60 minutes, more preferably within 45 minutes, still more preferably within 30 minutes, and even still more preferably within 25 minutes. It is also desirable to detect toxins at or below about 500 ppt, preferably at or below about 100 ppt, more preferably at or below about 50 ppt, even more preferably at or below about 25 ppt, and still more preferably at or below about 12.5 ppt.

Aflatoxins include, but are not limited to, aflatoxins G₁, G₂, B₁, B₂, and M₁. Preferably, the invention provides columns, kits, and methods for detecting levels of AFM₁ at or below about 50 ppt, even more preferably at or below about 25 ppt, and still more preferably at or below about 12.5 ppt.

The invention is useful for detecting and measuring low levels of other toxins and also for impurities in a wide range of substances and not merely in milk, milk products, wine, coffee, tea, and other foods and beverages. Rather, it is envisaged that the invention will have a broad applicability with respect to affinity column purification.

### DEFINITIONS

As used in the specification and claims, the singular form “a”, “an” and “the” include plural references unless the context clearly dictates otherwise. For example, the term “a molecule” also includes a plurality of molecules.

As used herein, an “analyte” is the element of the sample to be detected or isolated. An analyte includes, but is not limited to, a toxin, a toxoid, a toxic substance, a poisonous substance, a poison, or a specific impurity of interest. An analyte may be of biological or non-biological origin. In some embodiments, the analyte specifically binds a binding reagent. In some embodiments, the presence or absence of the analyte may be used to detect, for example, contamination of a sample. Alternatively, the presence or absence of the analyte may be used to determine the physiological condition of an organism from which the sample was obtained. A wide range of other uses will occur to one of skill in the art.

As used herein, a “toxin” includes a toxoid, a toxic substance, a poisonous substance, or a poison of biological or non-biological origin. In some embodiments, a toxin causes damage or disease to a cell or an organism.

As used herein, “specificity” refers to the ability of an antibody to discriminate between antigenic determinants. It also refers to the precise determinants recognized by a particular receptor or antibody. It also refers to the ability of a receptor to discriminate between substrates, such as drugs. With respect to nucleic acids, it refers to identity or complementarity as a function of competition or recognition/binding, respectively. “Specificity” of recognition or binding may be affected by the conditions under which the recognition or binding takes place (e.g., pH, temperature, salt concentration, and other factors known in the art).

As used herein, a “ligand” is a molecule or molecular complex that can be bound by another molecule or molecular complex. The ligand may be, but is not limited to, a molecule or molecular complex bound by a receptor, or it may be a complementary fragment of nucleic acid.

As used herein, an “antibody” (Ab) is protein that binds specifically to a particular substance, known as an “antigen” (Ag) (described infra). An “antibody” is any immunoglobulin, including antibodies and fragments thereof, that binds a specific epitope. The term encompasses polyclonal, monoclonal, and chimeric antibodies (e.g., multispecific antibodies).

As used herein, an “antigen” (Ag) is any substance that reacts specifically with antibodies or T lymphocytes (T cells). An “antigen-binding site” is the part of an immunoglobulin molecule that specifically binds an antigen.

As used herein, “biological sample” includes samples of tissues, cells, blood, fluid, milk, or other materials obtained from a biological organism. It also includes a biological organism, cell, virus, or other replicative entity.

As used herein, “food” includes any substance or product intended for human or animal consumption, regardless of nutritional value. “Food” includes beverages, including milk and water. It also includes ingredients or substances used in the preparation of food (e.g., oil, fat, spices, flavorings, etc.). “Food” may be processed, partially processed, or unprocessed. It can include artificial and/or natural ingredients.

As used herein, “beverage” or “drink” includes any liquid or colloidal substance intended for human or animal consumption, regardless of nutritional value. “Beverages” include milk and other dairy drinks (e.g., flavored milk, cream, eggnog, milkshakes, frappes), water, coffee and coffee-based beverages, tea and tea-based beverages, other infusions (e.g., herbal tea/tisane, roasted grain or nut beverages), beer, wine, other alcoholic substances (e.g., whisky, vodka, gin, brandy, rum, schnapps, liqueurs), fruit and vegetable juices and ciders, sap, soft drinks regardless of degree of carbonation (e.g., mixed juice beverages, syrup and powdered drinks, sodas and colas, sports and energy drinks), non-dairy milks (e.g., soy milk, rice milk, coconut or almond milk), hot chocolate, and hot cocoa. “Beverages” may be processed, partially processed, or unprocessed. Wine and beer may be alcoholic beverages, may have reduced alcohol or may be non-alcoholic. Coffee and tea may be undecaffeinated (i.e., “regular”) or partially or wholly decaffeinated. Tea may be non-oxidized, partially oxidized, or fully oxidized. “Beverages” can include artificial and/or natural ingredients. “Beverages” may be enriched with vitamins and minerals or may be flavored with spices, herbs, seasonings, juices, flowers, berries, or other flavorings or substances (e.g., toasted rice).

As used herein, “milk” includes raw milk, whole milk, low-fat milk, defatted or skim milk, and homogenized and/or pasteurized milk. “Milk products” include milk and substances made with milk, including but not limited to cheeses, yoghurt, creams, butter, ice cream, powdered milk, condensed milk, and the like.

When not otherwise stated, “substantially” means “being largely, but not wholly, that which is specified.”

### EXAMPLES

### Example 1

A mobile bead column is prepared in accordance with the present invention using resin material having a particle size in the range of about 45 to about 165 μm with the desired antibodies attached to the resin. A cap covers the outflow opening at the lower end of the column, and the column is filled with an appropriate buffer known in the relevant art. The resin is level within the column.

The cap covering the outflow opening is removed, and a liquid or colloidal sample is applied to the column. Sample application may be performed using a pipet, a micropipet, a medicine dropper, a funnel, a syringe, a second column, or other means known in the art. The rate of outflow and inflow are controlled such that the contents of the column do not exit from the inflow opening at the upper end of the column. The flow rate may be controlled by stopcocks at one or both ends of the column. The flow continues until substantially all of the liquid or colloid is passed through the column. Pressure may also be applied to the column to control or increase the flow and speed the overall process. It may be desirable to apply pressure when the level of the liquid or colloid reaches the upper frit.

Preferably, the upper frit is removed and discarded. The column is washed with a few to several volumes of an appropriate wash solution known in the relevant art. The wash solution is allowed to flow into the column until the column is between about one-third to about two-thirds full. The flow is stopped, and the column is capped at both ends. The capped column is inverted one or more times, or is shaken, such that the resin is thoroughly suspended while being washed by the wash buffer. After the upright position of the column is resumed, the column is uncapped at both ends and the remaining wash solution is removed. Additional washing cycles, with or without shaking or inversion, may be performed. During washing, the flow rate may be faster than during application of the sample or elution. Pressure may also be applied to the column to control or increase the flow and speed the overall process.

After the last wash cycle, a desired amount of an elution solution or elution buffer is applied to the column. Appropriate elution solutions, buffers, and their desired amounts are known in the relevant art. Typically, the volume of elution solution is minimized in order to concentrate the eluent, which is collected and analyzed or subjected to other procedures.

### Example 2

A mobile bead column was prepared in accordance with the present invention using Sepahrose 4B from Amersham Biosciences (Piscataway, N.J.) with anti-aflatoxin monoclonal antibody attached to the resin to provide about 5 mg antibody per one ml of resin. In a 3 ml column having a diameter of 8.93 mm, a supporting porous disk (frit) was positioned at the bottom of the column barrel in a manner to permit flow out of the column. 250 μl of the resin was layered on the disk. Finally, another porous disk was positioned one inch above the bottom of the column barrel to contain the resin.

A cap was placed to cover the outflow opening at the lower end of the column, and the column is filled with phosphate buffered saline (“PBS”; 137 mM NaCl; 2.7 mM KCl; 5.4 mM Na₂HPO₄; 1.8 mM KH₂PO₄; pH 7.4). The side of the column was tapped to level the resin layer so that the top of the resin layer was perpendicular to the column.

The plunger of a 60 ml syringe was removed and discarded, and the narrower outflow opening of the syringe barrel was fitted with a stopcock. The syringe barrel was vertically fixed so that the wider opening was at the top and the narrower opening with the stopcock was at the bottom. The opposite end of the stopcock was attached with a column coupling inserted into the upper opening of the column. With the stopcock in a closed position, a 40 ml sample of control milk (aflatoxin M₁-free by HPLC analysis) was loaded into the wider opening at the top of the syringe barrel. The cap covering the lower opening of the column was removed, and the stopcock was opened so that the sample flowed by drops into the column. The flow rate was adjusted so that the rate of flow from the column was 1-2 drops per second.

As the upper level of the remaining sample reached the upper frit, the rate of flow from the column slowed. The wider opening at the top of the syringe barrel was plugged and air pressure was applied through the plug. The process continued until the remaining milk sample had run through the column. The upper frit was removed and discarded.

The plunger of a 10 ml syringe was removed and discarded, and the narrower outflow opening of the syringe barrel was fitted with a stopcock similar to the previous arrangement. 10 ml of a 10% v/v wash solution of methanol in water was loaded into the wider opening at the top of the syringe barrel. The rate of flow from the column was approximately 2-3 drops per second.

When the upper level of the remaining wash solution was halfway down the column, the column was capped at the lower opening, removed, and capped at the upper opening. The column was thoroughly inverted until all the resin was removed from the lower frit (about ten inversions). The column was replaced upright and the caps were removed to allow the remaining wash solution to drain. The column was then washed twice with 10 ml aliquots of 10% methanol in water in the previous manner, but without the inversions. The wash solution was allowed to drain completely. (Optionally, a pump is used to speed drainage.)

An elution solution of 80% v/v methanol in water was prepared, and 1 ml was used for elution at a rate of 1-2 drops per second into a test tube until the solution had drained completely. A 1 ml aliquot of diluted AlfaTest® Developer (Vicam LLP; prepared from 5 ml [catalog no. 32010 with 0.03% bromine] diluted with 45 ml distilled water in accordance with the manufacturer's instructions) was added to the eluent and then vortexed before being placed into a precalibrated Vicam Series 4 Fluorometer and the level of AFM₁ was analyzed after 60 seconds.

### Additional Examples

The following examples illustrate detection of aflatoxin M₁ from raw milk samples using a column containing 250 μl of a first resin. Spiked samples were used to determine limit of detection, linearity, precision and reproduceability.

### Materials and Methods

### Reagents and Chemicals

The following reagents were obtained from Vicam, LLP (Watertown, Mass.):

| | Part # |
|---|---|
| Afla M₁^{FL+} Columns (25/box) | G1047 |
| AflaTest Developer (25 ml) | G5002 |
| AflaTest M ™ Calibration Standards (3 Calibrators, 10 mL | 33040 |
| each) | |
| Methanol, HPLC Grade (4 × 4 liters) | 35016 |

Other reagents were: Reverse osmosis (RO) purified water obtained using a Millipore (Milli RO 12plus system). Aflatoxin M₁ (Supelco, PA, USA) at 10 μg/ml in acetonitrile.

### Reagent Preparation

AflaTest® Developer Solution: 5.0 ml AflaTest® Developer concentrate solution (Vicam #32010) was measured and placed in the 2 oz. amber glass bottle of a 50 ml bottle dispenser for Developer. (Vicam part # 20600) 45.0 ml purified water was added and mixed well. The bottle dispenser top was secured tightly. The dilute Developer solution was capped tightly when not in use. Dilute Developer was not used more than 8 hours after preparation.

### Apparatus and Equipment

The following equipment was obtained from Vicam, LLP (Watertown, Mass.):

| | Part # |
|---|---|
| Series 4 Fluorometer | G8000 |
| Frit-picker | G1129 |
| Afla M₁ single position pump stand with pump (for | G1106 |
| single sample) | |
| Afla M₁ 4 position pump stand with 2 pumps (for | G1107 |
| multiple samples) | |
| Cuvette rack | 21010 |
| Graduated cylinder, 50 ml | 20050 |
| Wash bottle, 500 ml | 20700 |
| Disposable plastic beakers (25) | 36010 |
| 50 ml Bottle dispenser for Developer | 20600 |
| Micro-pipette Tips for 1 ml Micro-pipettors (100) | 20656 |

Other equipment: Centrifuge capable of handling 50 ml Falcon centrifuge tubes and obtaining 2000×g RCF.

### Procedure

1.0 Calibration Settings: Use AflaM Calibration Standards

| Instrument | Green | Red | Yellow |
|---|---|---|---|
| Series 4 VICAM V1 | −25 | 500 | 230 ± 5 |

Readout would be in parts per trillion of aflatoxin M₁.

2.0 Set Up:
2.1 The fluorometer was calibrated weekly.
2.2 Diluted AflaTest® Developer solution was prepared daily.
2.3 Methanol:water (80:20) and methanol:water (10:90) solutions were prepared every week or as needed.
2.4 A reagent blank was prepared by mixing 1 ml methanol:water (80:20)+1 ml diluted Developer in a cuvette. The reagent blank read 0 ppt on a calibrated fluorometer.
2.5 2 ml of methanol:water (10:90) in a cuvette read 0 ppt on a calibrated fluorometer.

3.0 Sample Preparation:
3.1 Approximately 50 ml milk was centrifuged at 2000×g for 10 minutes.
3.2 The skim portion (bottom layer) of the milk was carefully removed for analysis without disturbing the top fat layer. 40 ml of skim milk was used for each affinity column.

4.0 Column Preparation:
The Afla M₁^{FL+} column is a mobile resin column. Prior to use, the level of resin inside the column was horizontal. If the resin was not already horizontal, the lower side of the column was gently tapped several times with a finger to level the resin.

5.0 Column Chromatography:
5.1 40 ml skim milk was passed completely through Afla M₁^{FL+} affinity column at a rate of about 1-2 drops/seconds until air comes through column.
5.2 The Afla M₁^{FL+} column was removed from the loading syringe barrel. The top frit was removed from the Afla M₁^{FL+} column using the Frit-picker.
5.3 The Afla M₁^{FL+} column headspace was filled with methanol:water (10:90) solution. The Afla M₁^{FL+} column was placed on a clean glass syringe barrel.
5.4 The glass syringe barrel was filled with 10 ml methanol:water (10:90) solution. This solution was passed through the column at a rate of about 2-3 drops/second until the level of solution was approximately 1 inch above the top of the resin bed.

5.5 The column was removed from the syringe barrel and capped with the cap that came with the column. The column was inverted 10 times until the resin beads are completely washed from the column bottom frit.
5.6 The top cap was removed from the column. The column headspace was filled with methanol:water (10:90) and the column was placed back onto the syringe barrel.
5.7 10 ml of methanol:water (10:90) was passed through the column at a rate of about 2-3 drops/seconds.
5.8 Step 5.7 was repeated once more until air came through the column.
5.9 The affinity column was eluted by passing 1 ml methanol:water (80:20) through column at a rate of about 1 drop/second until air came through the column.
5.10 1.0 ml of diluted AflaTest® Developer was added to the eluate in the cuvette and mixed well. The cuvette was placed in a calibrated fluorometer. The aflatoxin concentration was read after 60 seconds.

6.0 Limit of Detection: At or Below 12.5 ppt

7.0 Assay Range: 0-200 ppt

### Examples 3-6

### Limit of Detection

For this study, the limit of detection was defined as the smallest amount of aflatoxin M₁ which is reproducibly and accurately detected. Raw milk samples were collected from two different dairy famms, and were determined to be aflatoxin M₁-free by HPLC analysis. The aflatoxin M₁-free milk samples were spiked with aflatoxin M₁ (Supelco, PA, USA) at 0, 12.5, 25, and 50 ppt. Two independent experiments were done on two different days. The results presented in Table 1 show the values obtained without correction for column recovery

TABLE 1
Limit of Detection.

| | 0 ppt spike | 12.5 ppt spike | 25 ppt spike | 50 ppt spike |
|---|---|---|---|---|
| | 0 | 14 | 28 | 56 |
| | 0 | 20 | 28 | 56 |
| | 0 | 15 | 31 | 58 |
| | 5.5 | 8 | 30 | 60 |
| | 0 | 10 | 29 | 64 |
| | 0 | 12 | 29 | 60 |
| | | 8 | 24 | 62 |
| | | | 32 | 44 |
| | | | 30 | 50 |
| | | | 25 | 55 |
| | | | 25 | 60 |
| Mean | 0.92 | 12.43 | 28.27 | 56.82 |
| SD | 2.24 | 4.31 | 2.61 | 5.71 |
| % CV | 2.45 | 34.72 | 9.24 | 10.04 |

The limit of detection using the protocol described above was at or below 12.5 ppt.

### Examples 7-12

### Linearity

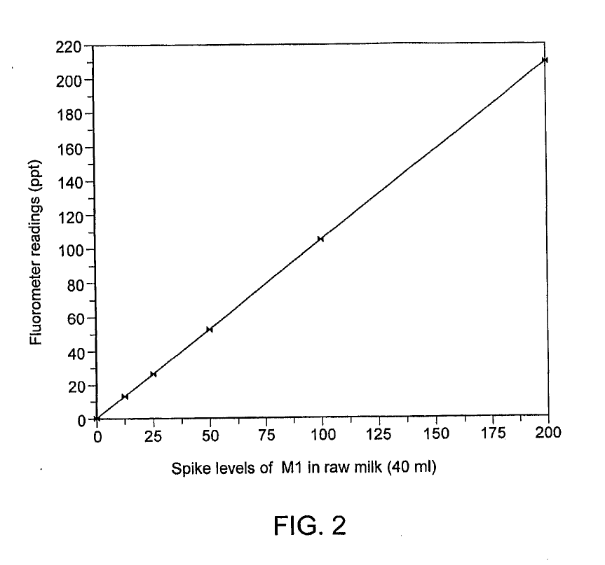

Linearity was determined using Aflatoxin M₁-spiked raw milk samples ranging from 0 ppt to 200 ppt. Individual data points are presented in Table 2. The graph (FIG. 2) shows the linear regression analysis equation for the amount of aflatoxin M₁ measured by fluorometer versus the amount spiked.

TABLE 2
Linearity.

| Spike level | | Replicate 1 | Replicate 2 | Replicate 3 | Replicate 4 | Mean |
|---|---|---|---|---|---|---|
| 0 | ppt | 0 | 0 | 0 | 0 | 0 |
| 12.5 | ppt | 12 | 10 | 12 | 11 | 11.25 |
| 25 | ppt | 23 | 25 | 27 | 27 | 25.5 |
| 50 | ppt | 65 | 53 | 59 | 61 | 59.5 |
| 100 | ppt | 110 | 100 | 98 | 95 | 100.75 |
| 200 | ppt | 200 | 210 | 220 | 210 | 210 |

The linear regression equation is Y=1.046X+0.307, r=0.998. The correlation coefficient (r) of 0.998 from the above linear regression equation indicates that this method exhibits excellent linearity.

### Examples 13 and 14

### Precision

Precision was determined using raw milk samples spiked with aflatoxin M₁ at 25 and 50 ppt. The results presented below in Table 3 (25 ppt) and Table 4 (50 ppt>were obtained from three independent experiments, using four different raw milk samples, performed on three different days.

TABLE 3
Precision for 25 ppt samples.
25 ppt spiked sample results

| | Sample 1 | Sample 2 | Sample 3 | Sample 4 | |
|---|---|---|---|---|---|
| | 28 | 26 | 23 | 23 | |
| | 28 | 26 | 27 | 25 | |
| | 31 | | 29 | 27 | |
| | 30 | | 29 | 27 | |
| | 29 | | 29 | | |
| | 29 | | 26 | | |
| | 24 | | 24 | | |
| | 32 | | | | |
| | 30 | | | | |
| | 25 | | | | |
| | 25 | | | | |
| Mean | | | | | 27.09 |
| SD | | | | | 2.54 |
| % CV | | | | | 9.37 |

TABLE 4
Precision for 50 ppt samples.
50 ppt spiked sample results

| | Sample 1 | Sample 2 | Sample 3 | Sample 4 | |
|---|---|---|---|---|---|
| | 56 | 59 | 49 | 65 | |
| | 56 | 53 | 56 | 53 | |
| | 58 | 57 | 51 | 59 | |
| | 60 | 57 | 60 | 61 | |
| | 64 | 48 | | | |
| | 60 | 51 | | | |
| | 62 | 57 | | | |
| | 50 | 53 | | | |
| | 55 | 62 | | | |
| | 60 | 59 | | | |
| | | 57 | | | |
| Mean | | | | | 56.83 |
| SD | | | | | 4.42 |
| % CV | | | | | 7.79 |

Conclusion: The results above show a good precision (with a CV of less than 10%) for aflatoxin M₁ at 25 and 50 ppt.

### Examples 15-20

### Reproducibility

Raw milk samples spiked at 25 and 50 ppt were analyzed by three independent operators. Individual results are presented in Table 5 (25 ppt) and Table 6 (50 ppt).

TABLE 5
Reproduciblity for 25 ppt samples.
25 ppt spiked sample results

| | Operator 1 | Operator 2 | Operator 3 | Overall |
|---|---|---|---|---|
| | 23 | 21 | 21 | |
| | 29 | 22 | 34 | |
| | 30 | 22 | 27 | |
| | 23 | 23 | | |
| | 23 | | | |
| Mean | | | | 24.83 |
| SD | | | | 4.17 |
| % CV | | | | 16.81 |

TABLE 6
Reproduciblity for 50 ppt samples.
50 ppt spiked sample results

| | Operator 1 | Operator 2 | Operator 3 | Overall |
|---|---|---|---|---|
| | 51 | 47 | 58 | |
| | 55 | 49 | 62 | |
| | 52 | 59 | 54 | |
| | 56 | 54 | | |
| | 53 | | | |
| Mean | | | | 54.17 |
| SD | | | | 4.24 |
| % CV | | | | 7.83 |

Conclusion: The results above show good reproducibility at both 25 and 50 ppt levels.

Throughout this application, various publications including United States patents, are referenced by author and year and patents by number. The disclosures of these publications and patents in their entireties are hereby incorporated by reference into this application in order to describe more fully the state of the art to which this invention pertains.

The invention has been described in an illustrative manner, and it is to be understood that the terminology which has been used is intended to be in the nature of words or description, rather than of limitation.

Obviously, many modifications and variations of the present invention are possible in light of the above teachings. It is, therefore, to be understood that within the scope of the described invention, the invention may be practiced otherwise than as specifically described.

1. A method of analyzing a single liquid sample for detecting the presence of an analyte in a sample or for analyzing the level of an analyte in a sample, wherein the method comprises:
a. providing an immunoaffinity column comprising a mobile resin configuration, wherein the immunoaffinity column comprises:
i. a lower end including an outflow opening;
ii. a lower porous support;
iii. a layer of resin on the lower porous support, the resin having specific affinity for the analyte;
iv. an upper porous support; and
v. an upper end including an inflow opening;
wherein the resin between the lower porous support and the upper porous support is structured and arranged to permit removal of the upper frit from the column without substantial removal of resin;
b. loading the column with a predetermined amount of a liquid sample suspected of containing the analyte;
c. binding the analyte to the antibody on the column;
d. loading the column with a wash solution
e. suspending the resin in the wash solution;
f. removing the wash solution from the column;
g. eluting the analyte in eluant; and
h. analyzing the eluant for the presence of the analyte.

2. The method of claim 1, wherein the volume of the resin in the column is less than the total packed volume of the column between the lower porous support and the upper porous support.

3. The method of claim 1, wherein the volume of the resin in the column is no greater than 50% of the total packed volume of the column between the lower porous support and the upper porous support.

4. The method of claim 1, wherein the volume of the resin in the column is no greater than about 40% of the total packed volume of the column between the lower porous support and the upper porous support.

5. The method of claim 1, wherein the volume of the resin in the column is no greater than about 30% of the total packed volume of the column between the lower porous support and the upper porous support.

6. The method of claim 1, wherein the volume of the resin in the column is no greater than about 25% of the total packed volume of the column between the lower porous support and the upper porous support.

7. The method of claim 1, wherein the volume of the resin in the column is no greater than about 20% of the total packed volume of the column between the lower porous support and the upper porous support.

8. The method of claim 1, wherein the column is structured and arranged to recover at least 60% of the analyte in a 40 ml sample being analyzed, the analyte being selected from the group consisting of ochratoxin, zearalenone, aflatoxin, fumonisin, T-2, HT-2, and deoxynivalenol.

9. The method of claim 8, wherein the column is structured and arranged to recover at least about 70% of the analyte in a 40 ml sample being analyzed.

10. The method of claim 8, wherein the column is structured and arranged to recover at least about 80% of the analyte in a 40 ml sample being analyzed.

11. The method of claim 1, wherein the sample comprises milk or a milk product and the analyte is an aflatoxin.

12. The method of claim 11, wherein the aflatoxin is aflatoxin G₁, G₂, B₁, B₂, or M₁.

13. The method of claim 11, wherein the aflatoxin is aflatoxin M₁.

14. The method of claim 1, wherein the column has a detection limit at or below about 100 ppt.

15. The method of claim 14, wherein the column has a detection limit at or below about 50 ppt.

16. The method of claim 14, wherein the column has a detection limit at or below about 25 ppt.

17. The method of claim 14, wherein the column has a detection limit at or below about 15 ppt.

18. The method of claim 14, wherein the column has a detection limit at or below about 12.5 ppt.

19. The method of claim 1, wherein the column is structured and arranged to have a flow rate of sample fluid through the column of at least 1-2 drops per second.

20. The method of claim 1, wherein the resin comprises about 5 mg of antibody per ml of resin.

21. The method of claim 1, wherein the column further comprises at least one of the following:
a. a removable cap covering the lower end to prevent transfer of substances through the outflow opening; or
b. a removable cap covering the upper end to prevent transfer of
substances through the inflow opening; and
and wherein the resin is suspended by at least one inversion of the column.

22. The method of claim 1, wherein the analyte is extracted from a food using a water-based or water compatible solvent.

23. The method of claim 22, wherein the food comprises a milk product.

24. The method of claim 1, wherein the analyte is extracted from milk or a milk product.

25. The method of claim 24, wherein the analyte is extracted from de-fatted milk.

26. The method of claim 1, wherein the resin is suspended by inversion of the column, by vortexing the column, or by shaking the column.

27. The method of claim 1, wherein the resin is suspended by inverting the column until the resin is released from the lower porous support.

28. The method of claim 1, wherein the upper porous support is removed from the column following the step of binding the analyte to the antibody on the column.

29. An immunoaffinity column comprising a mobile resin configuration for detecting the presence of an analyte in a sample or for analyzing the level of an analyte in a sample, wherein the immunoaffinity column comprises:
a. a lower end including an outflow opening;
b. a lower porous support;
c. a layer of resin on the lower porous support, the resin having specific immunoaffinity for the analyte;
d. an upper porous support; and
e. an upper end including an inflow opening;
wherein the resin between the lower porous support and the upper porous support is structured and arranged to permit removal of the upper frit from the column without substantial removal of resin.

30-49. (canceled)

50. A kit for detecting the presence of an analyte in a sample or for analyzing the level of a analyte in a sample, wherein the kit comprises:
a. the immunoaffinity column of claim 29 having a mobile resin configuration;
b. a removable cap covering the lower end to prevent transfer of substances through the outflow opening;
c. a removable cap covering the upper end to prevent transfer of substances through the inflow opening; and
d. instructions for use.

51-57. (canceled)
